(19) United States
(12) Patent Application Publication
(10) Pub. No.: US 2010/0031507 A1
(43) Pub. Date: Feb. 11, 2010

(54) Method for manifold manufacture and assembly

(76) Inventors: Suresh Deepchand Shah, Troy, MI (US); Mohinder Singh Bhatti, Williamsville, NY (US); Karl Paul Kroetsch, Williamsville, NY (US); Gary Christopher Victor, North Tonawanda, NY (US)

Correspondence Address: Delphi Technologies, Inc., M/C 480-410-202, PO BOX 5052, Troy, MI, 48007, US

(21) Appl. No.: 12/221,599

(22) Filed: Aug. 5, 2008

(51) Int. Cl. B23P 15/26

(52) U.S. Cl. 29/890.052

(57) ABSTRACT

A manifold assembly for a heat exchanger is manufactured and assembled by separately molding a tank portion and a header portion, and assembling the tank and header portions together by positioning them relative to each other and injecting a sealing substance in a cavity that is formed when the portions are so positioned. Ribs are incorporated in the tank and header portions to increase the interface area between the molded portions and the sealing substance, to achieve a mechanically sound, leak proof assembly without using gaskets or fasteners.

### TECHNICAL FIELD OF INVENTION

This invention relates to heat exchanger manifolds in general, and specifically to a method for manufacturing and assembling a plastic manifold assembly without requiring gaskets or fasteners.

### BACKGROUND OF INVENTION

A manifold for heat exchangers may be constructed by combining a molded tank portion with a molded header portion. The header portion of the manifold typically interfaces with a heat exchanger core comprising a plurality of finned tubes that transport a liquid coolant to a similar manifold at the opposite end of the core. Heat is conducted from the coolant through the walls of the tubes to the fins, where the heat is convected to the surrounding air. To achieve the necessary seal between the tank portion and the header portion to prevent coolant leakage it is often necessary to provide a gasket, either preformed or form-in-place. If a preformed gasket is used, care must be taken to maintain the proper position of the gasket throughout the assembly process. Form-in-place gaskets present challenges in manufacturing in terms of ensuring the material is dispensed in the proper location without dripping onto improper locations. Dispense nozzles may need to be purged periodically if the material is not dispensed in a timely manner, resulting in wasted material and associated disposal costs. Mechanical attachment of the tank portion to the header portion may require clinched fasteners around the periphery of the assembly, and may introduce failure modes associated with the clinched assembly process. It would be desirable to manufacture and assemble sealed manifold assemblies for heat exchangers without requiring additional gaskets and without requiring clinched fasteners.

### SUMMARY OF THE INVENTION

The subject invention provides a method for manufacturing and assembling a heat exchanger manifold assembly that provides a sealed assembly without requiring additional gaskets and without requiring clinched fasteners.

In accordance with this invention, a tank portion and a header portion are each molded using known injection molding processes. Each of the tank portion and the header portion incorporates a peripheral flange, and each flange defines a pocket peripherally surrounding the open face of each portion. Within each pocket is a rib that extends from the floor of the pocket. Several options are available for the disposition of these ribs, which are discussed in further detail below. The ribs are oriented such that they are substantially parallel to the pull axis of the molding tools used to form the tank portion and the header portion. This allows the ribs to be formed without requiring extra slides in the molding tools.

The ribs are located and sized so that when the tank portion and header portion are abutted together into their assembled positions, clearance remains between the ribs, as well as from each rib to the confines of the pockets. As a result, when the tank portion and header portion are brought together in their assembled positions the pockets in both flanges define a single connected volume. To complete the assembly of the manifold assembly, the tank portion and header portion are abutted into their assembled positions. Then a secondary injection step is performed to fill the volume defined by the pockets with a sealing substance in liquid form. Potentially this sealing substance is a thermoplastic resin in a molten state or a thermoset material injected in liquid form. As the sealing substance solidifies, it adheres to the surfaces of the pocket walls, pocket floor, and ribs, resulting in a strong, leak proof assembly. By including ribs in the pockets, the available surface area for interfacing with the sealing substance is increased, thus improving the strength of the completed assembly. In addition, the inclusion of ribs in the pockets decreases the probability of having a coolant leak path to the exterior of the manifold, thereby contributing to sealing the assembly. Several rib configurations are possible, as further described below.

### BRIEF DESCRIPTION OF DRAWINGS

This invention will be further described with reference to the accompanying drawings in which:

FIG. 1 is an isometric view showing the tank portion separate from the header portion according to an exemplary embodiment of the method of this invention.

FIG. 2 is a sectional view of a heat exchanger manifold assembly constructed according to an exemplary embodiment of the method of this invention.

FIG. 3 is a partial sectional view of the manifold assembly according to an exemplary embodiment of the method of this invention after injection of the sealing substance.

FIG. 4 is a partial sectional view showing the tank portion and header portion according to an exemplary embodiment of the method of this invention before assembly.

FIG. 5 is a perspective view showing continuous ribs in the tank portion and header portion according to an exemplary embodiment of the method of this invention before assembly.

FIG. 6 is a perspective view showing an embodiment comprising holes through the ribs.

FIG. 7 is a perspective view showing an embodiment comprising a bevel feature to assist in alignment during assembly.

FIG. 8 is a perspective view showing an embodiment comprising ribs with square crenellations.

FIG. 9 is a perspective view showing an embodiment comprising ribs with rounded crenellations.

FIG. 10 is a perspective view showing an embodiment comprising ribs with projections.

### DETAILED DESCRIPTION OF INVENTION

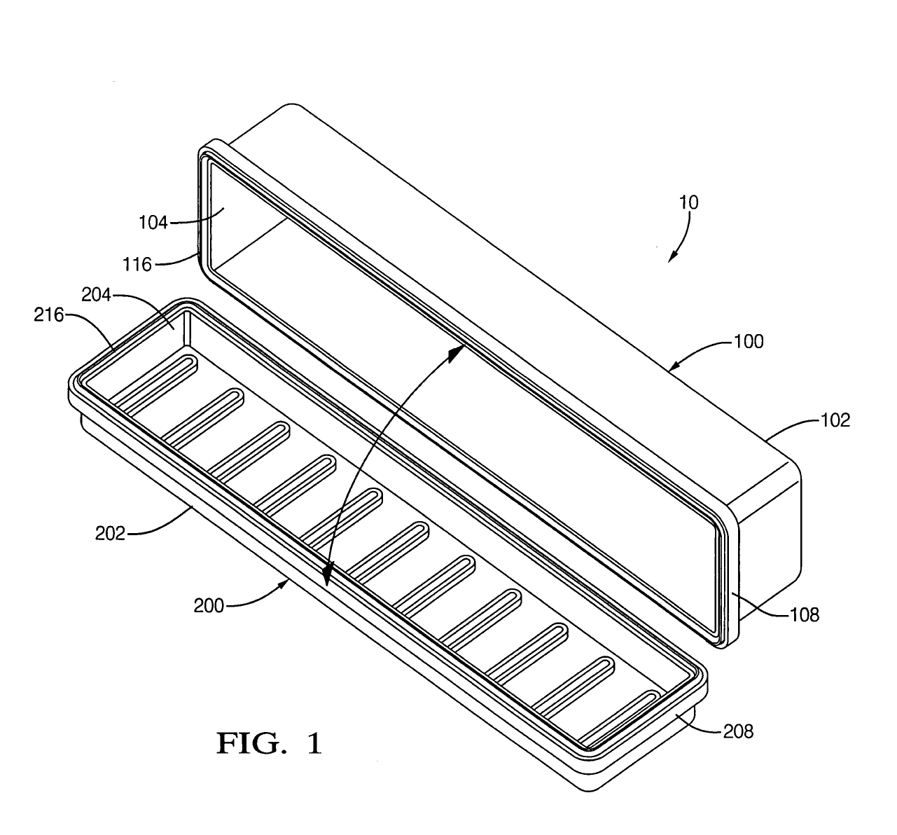

In accordance with exemplary embodiments of this invention, referring to FIGS. 1 through 10, a method for manufacturing and assembling a manifold assembly 10 includes providing a tank portion 100 and a header portion 200. FIG. 1 is an isometric view of the tank portion 100 and the header portion 200 positioned separate from each other. As shown in this figure, each of the tank portion 100 and the header portion 200 are generally box shaped. The tank portion 100 has a tank open face 104, and a tank closed face 102 opposite the tank open face 104. A tank flange 108 surrounds the periphery of the tank open face 104. The tank flange 108 includes a tank rib 116. Similarly, the header portion 200 has a header open face 204, and a header closed face 202 opposite the header open face 204. A header flange 208 surrounds the periphery of the header open face 204. The header flange 208 includes a header rib 216.

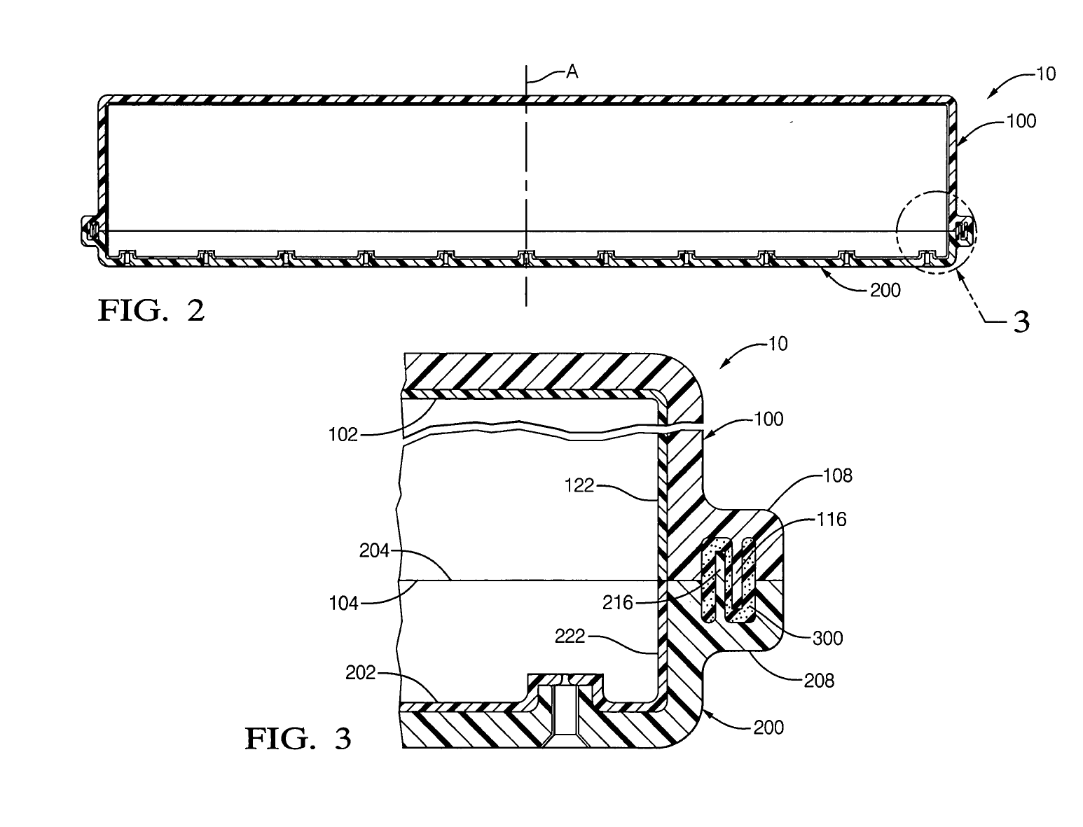

Referring to FIG. 2, a sectional view is presented that shows the salient features of the tank portion 100 and the header portion 200 as they relate to an exemplary embodiment of the manufacturing and assembly method. Both the tank portion 100 and the header portion 200 are generally box shaped and are formed by injection molding. The axis along which the mold tools close and withdraw is indicated as axis A. Inclusion of both the tank portion 100 and header portion 200 with a common axis A in FIG. 2 is not meant to indicate that both portions 100 and 200 are necessarily molded in the same tool or at the same time; this portrayal is intended to assist in defining the nomenclature assigned to the elements of the invention. It is also recognized that in order to mold other features in either the tank portion 100 or the header portion 200 beyond what is depicted, secondary slide mechanisms as are known in the art may be required in the mold tools.

FIG. 3 presents an enlarged sectional view of the interface between the tank portion 100 and the header portion 200. In FIG. 3, the tank portion 100 is shown to have a tank flange 108 surrounding the tank open face 104 and extending in a direction toward the tank closed face 102. The tank flange 108 includes a tank pocket and an integrally molded tank rib 116 extending in an axial direction from the floor of the tank pocket. Similarly, the header portion 200 has a header flange 208 surrounding the header open face 204 and extending in a direction toward the header closed face 202. The header flange 208 includes a header pocket and an integrally molded header rib 216 extending in an axial direction from the floor of the header pocket. The tank rib 116 and the header rib 216 are disposed so as to be mutually non-interfering when the tank portion 100 and header portion 200 are assembled together. The tank rib 116 and header rib 216 are also disposed to be spaced from the walls of the tank pocket and header pocket when the tank portion 100 and header portion 200 are assembled together. Thus, the tank rib 116, header rib 216, tank pocket, and header pocket cooperate to define a volume that is continuous in cross section when the tank portion 100 and header portion 200 are assembled together. Additionally, as previously shown in FIG. 1, the flanges, ribs, and pockets surround the open faces of the tank and header portions. As a result, in the assembled position there is a peripherally continuous common pocket volume. All regions of this common pocket volume are in fluid communication with all other regions of the common pocket volume around the entire periphery of the manifold assembly 10. As shown in FIG. 3, the sealing substance 300 is injected into the continuous volume defined by the tank rib 116, header rib 216, tank pocket, and header pocket. As the sealing substance adheres to the surfaces of the pocket walls and the ribs, it acts to hold the assembly together. The presence of the tank rib 116 and header rib 216 contribute to the surface area available for adherence of the sealing substance 300, thus adding to the strength of the assembly. Additionally, the sealing substance prevents coolant from leaking from the assembled heat exchanger manifold. The ribs also result in a longer leak path along the interface between the sealing substance 300 and the tank and header portions 100 and 200, thus decreasing the probability of a coolant leak from the assembled manifold.

FIG. 3 also indicates that the molded tank portion 100 may be molded to incorporate a tank barrier layer 122. Similarly, the molded header portion 200 may incorporate a header barrier layer 222. Ultimately the manifold assembly may be part of a heat exchanger containing a liquid coolant. By incorporating barrier layers 122 and 222 of a different material than is used for the remainder of the tank portion 100 and the header portion 200, it may be possible to lower costs by not requiring hydrolysis resistant additives in the regions of the tank portion 100 and header portion 200 that are not in direct contact with the coolant.

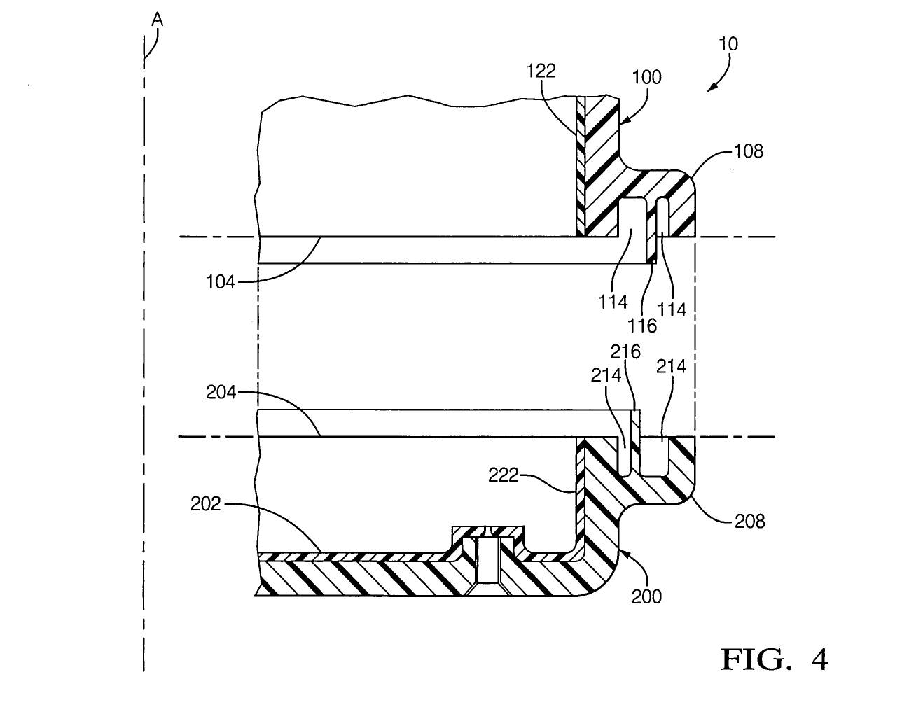

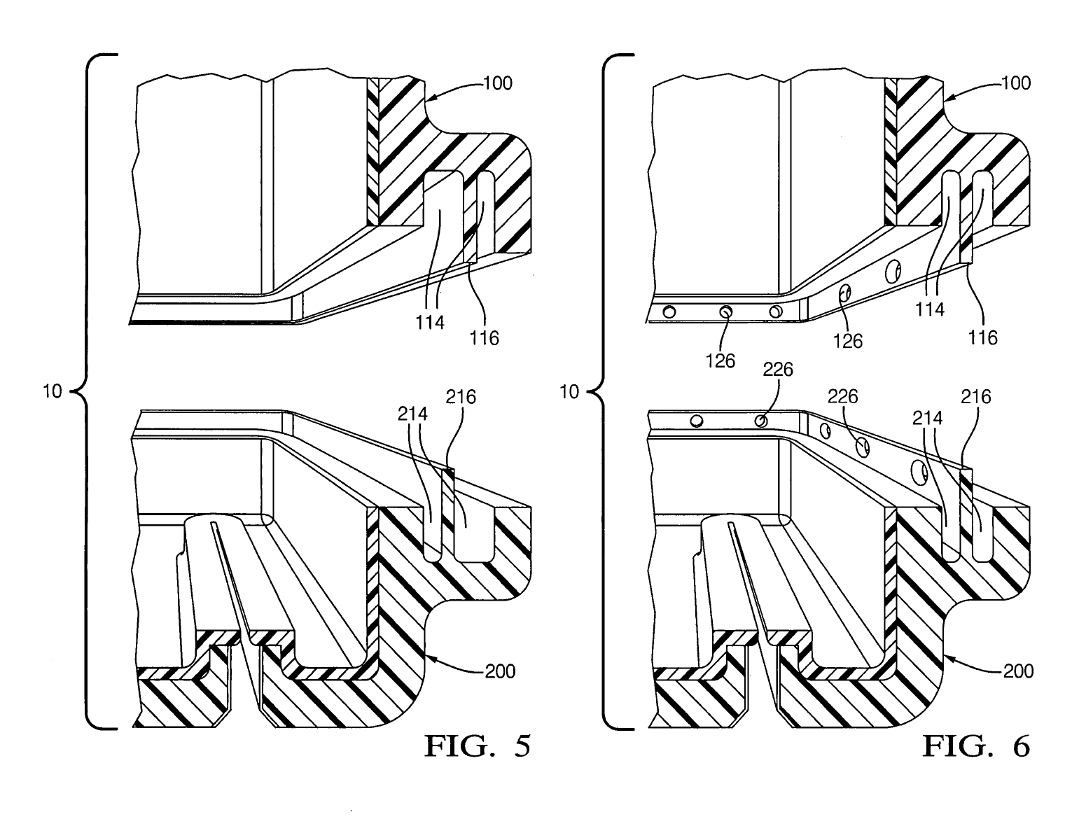

FIG. 4 is a partial sectional view, and FIG. 5 is a perspective view, showing the tank portion 100 and header portion 200 before assembly, to allow the geometries of each portion to be seen more clearly. As shown in FIG. 4, the tank flange 108 defines a tank pocket 114. An integrally molded tank rib 116 emerges from the floor of the tank pocket 114 and extends axially in the direction of the tank open face 104.

The header flange 208 defines a header pocket 214. An integrally molded header rib 216 emerges from the floor of the header pocket 214 and extends axially in the direction of the header open face 204. The tank pocket 114, tank rib 116, header pocket 214, and header rib 216 are sized and located such that when the tank portion 100 and the header portion 200 are brought together, clearance is maintained between the tank rib 116 and the header rib 216 as well as between each rib and the surfaces defining each pocket.

To complete the assembly process of the heat exchanger manifold assembly 10, the tank portion 100 and header portion 200 are positioned as indicated in FIG. 2. Then, a secondary injection molding process is used to inject a sealing substance 300 in liquid form to fill the common pocket volume. Potentially the sealing substance is the same polymer resin that is used to mold the tank portion 100 and the header portion 200 or a thermoset material injected in liquid form. As the sealing substance solidifies, it adheres to the surfaces of the common pocket volume that are formed by the sides and floor of the tank pocket 114, the tank rib 116, the sides and floor of the header pocket 214, and the header rib 216, thus forming a substantially monolithic structure to hold the tank portion to the header portion in a leak-free manner. Injection of the sealing substance can be accomplished by Die Slide Injection molding or by other molding method as are known in the art.

FIG. 6 depicts an embodiment in which the tank rib 116 and the header rib 216 contain holes 126, 226. These holes may be formed during the molding process by using slides in the die, or alternatively may be formed by a machining operation performed on the tank portion 100 or header portion 200 after molding. In the embodiment of FIG. 6, the injected sealing material can flow through the holes. When the sealing material solidifies, the geometry of the solidified material defined by the holes 126, 226 provides additional mechanical interlocking against separation of the assembled manifold in the axial direction. FIG. 6 shows the holes as being round, but holes of other shapes including but not limited to elongate, square, and rectangular are suitable.

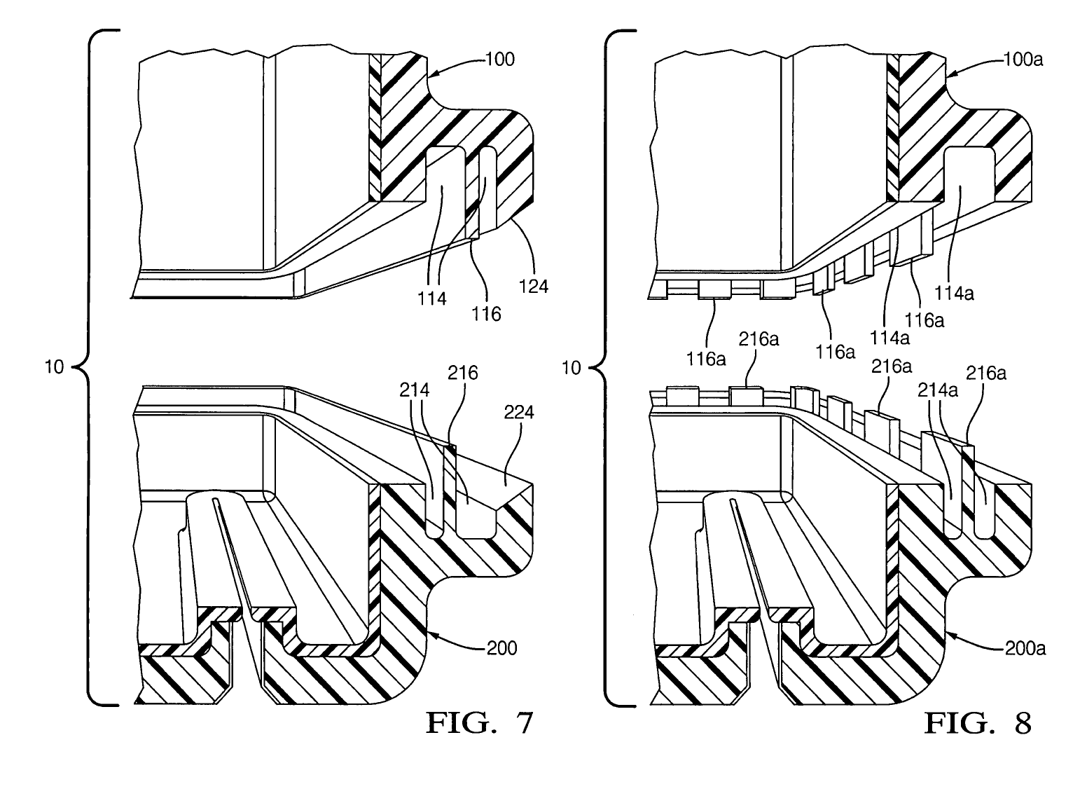

FIG. 7 is a partial section perspective view of an embodiment in which the tank rib 116 and the header rib 216 are as previously described, but the outer walls of the flange include complementary bevels 124 and 224. The bevels serve to urge the tank portion 100 and header portion 200 into radial alignment when the portions are brought together in the assembly process.

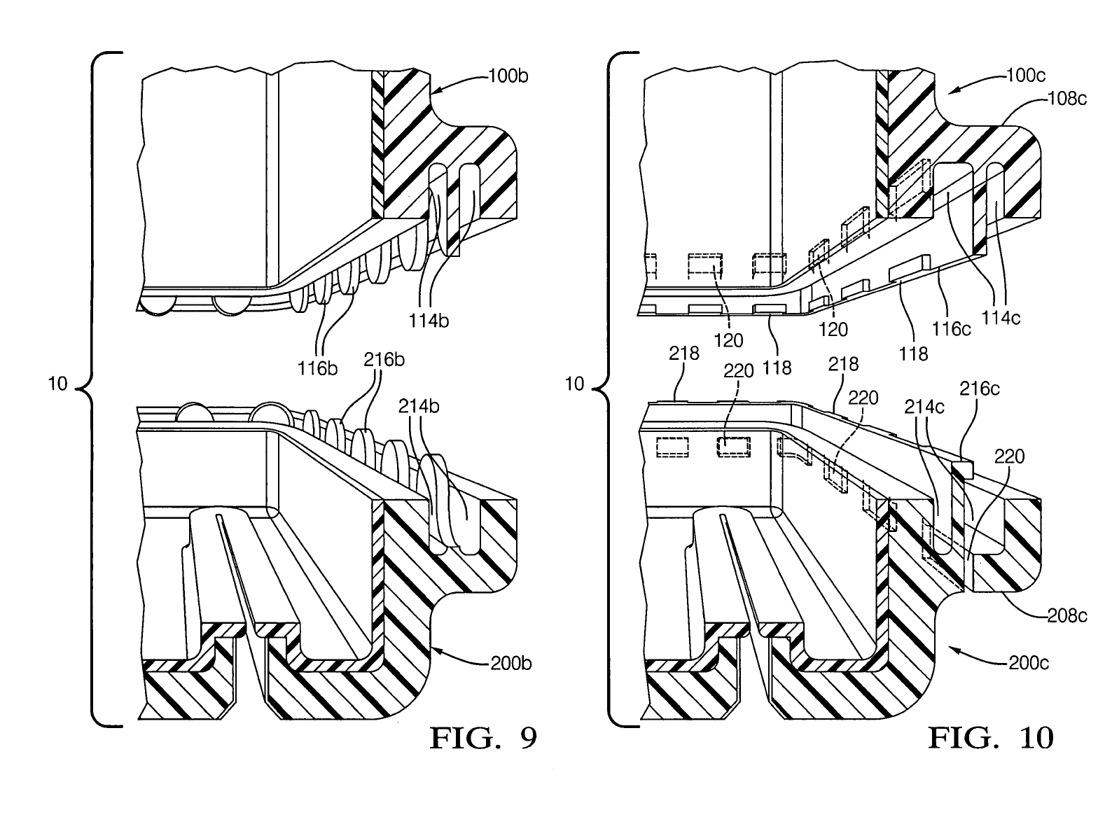

FIG. 8 and FIG. 9 depict alternate embodiments that feature crenellated tank rib 116a, 116b and header rib 216a, 216b. In these embodiments, the ribs are mutually non-interfering by virtue of each crenellation fitting between crenellations in the opposing portion. This configuration allows the ribs to be generally collinear, allowing the method of this invention to be applied while reducing the required widths of the tank pocket 114 and the header pocket 214, thereby allowing a smaller overall packaging envelope without reducing the coolant capacity of the heat exchanger manifold. In FIG. 8 the crenellated ribs 116a and 216a are depicted as rectangular in profile and in FIG. 9 the crenellated ribs 116b and 216b are depicted as having a curved profile, but the profiles of the crenellations could also be triangular, trapezoidal, or other shapes. Choice of the profile of the crenellations involves a tradeoff between the complexity of forming the profile in the mold tool, balanced against the requirement that the crenellation have sufficient strength at the root where it emerges from the pocket floor to withstand handling and to withstand the force imparted by the sealing substance as it is injected.

FIG. 10 depicts a modification that can be made to the design of either or both of the ribs. In this embodiment, a projection is molded into the tank rib 116c and/or the header rib 216c to allow the solidified injected sealing substance to form an interlocking structure with the ribs. A tank rib projection 118 on a tank rib 116 can be molded with a mold tool that contains a detail that projects through the floor of the tank pocket 114, resulting in a tank flange opening 120 through the floor of the tank flange 108c. Similarly, a header rib projection 218 on a header rib 216 can be molded with a mold tool that contains a detail that projects through the floor of the header pocket 214, resulting in an header flange opening 220 through the floor of the header flange 208c. In this way, such a projection 118, 218 can be molded with the mold tool closing and releasing along its pull axis A without adding secondary slide mechanisms. In addition, the tank flange opening 120 and/or the header flange opening 220 through the floor of the corresponding flange provides a path to the common pocket volume that facilitates venting when the sealing substance is injected, as well as providing visual access to the common pocket volume to allow the presence of the sealing substance to be verified.

While this invention has been described in terms of the embodiments thereof, it is not intended to be so limited, but rather only to the extent set forth in the claims that follow.

We claim:

1. A method for manufacturing and assembling a heat exchanger manifold having a tank portion and a header portion sealable along a peripheral edge, said method comprising the steps of:
providing a generally box shaped tank portion, said tank portion moldable along a predetermined axis, said tank portion comprising:
a tank flange surrounding the periphery of an open face of the tank, said tank flange defining a circumferentially complete tank pocket approximately U shaped in cross section open in the direction of the open face of the tank, and
a circumferentially complete tank rib integrally connected to and protruding in an axial direction from the floor of the tank pocket in the direction of the open face of the tank;
providing a generally box shaped header portion, said header portion moldable along a predetermined axis, said header portion comprising:
a header flange surrounding the periphery of an open face of the header, said header flange defining a circumferentially complete header pocket approximately U shaped in cross section open in the direction of the open face of the header, said header flange disposed to cooperate with the tank flange to define a common pocket volume when the tank portion and the header portion are brought together in an orientation wherein the tank portion abuts the header portion, and
a circumferentially complete header rib integrally connected to the header flange protruding from the floor of the header pocket in the direction of the open face of the header, said header rib disposed so as to extend into a portion of the common pocket volume not occupied by the tank rib when the tank portion and the header portion are brought together in an orientation wherein the tank flange abuts the header flange and the open face of the tank pocket faces the open face of the header pocket;
positioning the tank portion to the header portion in an orientation wherein the tank flange abuts the header flange with the open face of the tank facing the open face of the header; and
injecting a sealing substance in a liquid state into the common pocket volume.

2. The method of claim 1 wherein at least one of the tank rib or the header rib is disposed to extend axially beyond a plane defined by the periphery of the tank open face when the tank portion and header portion are brought together in the assembled configuration.

3. The method of claim 1 wherein at least one of the tank rib or the header rib defines at least one hole therethrough.

4. The method of claim 1 wherein the tank rib is offset from the header rib.

5. The method of claim 1 wherein the tank rib and header rib comprise crenellations.

6. The method of claim 1 wherein a side wall that defines the tank pocket comprises a beveled edge and a side wall that defines the header pocket comprises a complementary beveled edge adapted to urge the tank portion into alignment with the header portion when the tank portion and header portion are brought together in the assembled configuration.

7. The method of claim 1, further characterized in that at least one of the tank rib or the header rib includes at least one projection extending radially from the rib at a position separated from the corresponding pocket floor, said projection being defined by a mold tool comprising a detail that extends axially from the face of the projection that is nearest the corresponding pocket floor in a direction away from the corresponding open face, said mold tool detail thus defining an opening in the flange of the corresponding molded portion.

8. The method of claim 7 wherein the opening in the flange is adapted for providing venting when the sealing substance is injected.

9. The method of claim 7 wherein the opening is adapted to provide a means to visually inspect the assembly to verify the presence of the sealing substance.
